(19) United States
(12) Patent Application Publication
(10) Pub. No.: US 2016/0076887 A1
(43) Pub. Date: Mar. 17, 2016

(54) SUNDIAL COMPASS

(71) Applicant: Magpul Industries Corp, Boulder, CO (US)

(72) Inventor: Cody Joseph Carroll, Fort Collins, CO (US)

(21) Appl. No.: 14/485,638

(22) Filed: Sep. 12, 2014

(51) Int. Cl. G01C 17/34; G04B 49/02

(52) U.S. Cl. CPC G01C 17/34; G04B 49/02

(57) ABSTRACT

A system and method for determining one of true north and true south is described. One embodiment includes a sundial compass having a mounting base with a true north line, a dial plate, and a gnomon mount indicator. The true north line and dial plate are configured to indicate one of true north and true south based on a time clock calibration. A method of determining direction is also disclosed. The method includes determining calibration information, inserting a gnomon into a gnomon mount indicator, adjusting the gnomon based on the known calibration information and a time clock calibration, placing the sundial compass such that the true north line indicates one of true north and true south, and determining one of true north and true south.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to adventure sports. In particular, but not by way of limitation, the present invention relates to systems and methods for determining location based on the sun.

### BACKGROUND OF THE INVENTION

Determining one's direction of travel using landmarks, stars, the sun, and the earth's magnetic poles has been practiced for much of human history. One method of determining direction of travel involves using a magnetic compass.

At a basic level, a compass is nothing more than a magnetized needle, floating in a liquid, and responding to the Earth's magnetic field to allow the user to determine directions. Many compasses can be classified as one of four types, namely: fixed-dial, floating dial, cruiser, and orienteering. For hiking, mountaineering, and other adventure type sports, the orienteering type is often used. It is accurate to within about 2 degrees, does not require a separate protractor or map orientation, and is highly affordable.

An orienteering compass typically has three main parts: a magnetic needle, a revolving compass housing, and a transparent base plate. The north end of the magnetic needle is generally painted red and the south end is white. The housing is normally marked with the four cardinal points of north, east, south, and west and further divided into 2 degree graduations indicating the full 360 degrees of a circle. The bottom of the rotating housing is marked with an orienting arrow, and meridian lines. The base plate is marked with a ruler, an index line (bearing reading line), and a direction of travel arrow. The adventurer can orient his or her direction of travel based off of magnetic north.

Relatedly, a wristwatch having an hour hand can also be used as a makeshift compass. If the watch is set to the correct time, one can point the hour hand at the sun, and in that position, the point halfway between the current hour and the 12, is approximately south, if one is in the northern hemisphere. In the southern hemisphere, the point would be approximately north.

Conversely, a compass can be used as a watch. For example, in the northern hemisphere, knowing the sun is in the east at 6:00 am, southeast at 9:00 am, south at noon, southwest at 3:00 pm, and west at 6:00 pm, one can take a bearing on the sun, and get a rough idea of the current time.

A sundial is a device that tells the time of day by the position of the sun. In common designs such as the horizontal sundial, the sun casts a shadow from a style onto a dial face marked with lines indicating the hours of the day. The style is the time-telling edge of the gnomon, often a thin rod or a sharp, straight edge. As the sun moves across the sky, the shadow-edge aligns with different hour-lines. All sundials must be aligned with their styles parallel to the axis of the Earth's rotation to tell the correct time throughout the year. Specifically, the angle of the gnomon from horizontal should be set equal the sundial's geographical latitude.

Adventurers, particularly children, are interested in finding or using unique ways to navigate through their journeys. Using simple tools, such as sundials and compasses, are engaging for those adventurers, bringing them to a closer understanding and awareness of their environment.

Therefore, although there are countless ways of accurately determining one's location and direction, it is desirable to provide a unique system and method of determining one's direction of travel using the sun.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for determining direction. In one exemplary embodiment, the present invention can include a sundial compass having a mounting base with a true north line, a dial plate, and a gnomon mount indicator. The true north line and dial plate are configured to indicate one of true north and true south based on a time clock calibration.

In another embodiment, a method of determining direction is also disclosed. The method includes determining calibration information, inserting a gnomon into a gnomon mount indicator, adjusting the gnomon based on the known calibration information and a time clock calibration, placing the sundial compass such that the true north line indicates one of true north and true south, and determining one of true north and true south.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a front view of a sundial compass according to an embodiment;

FIG. 2 illustrates a back view of a sundial compass according to an embodiment;

FIG. 3 illustrates a front view of a bezel according to an embodiment; and

FIG. 4 illustrates a method according to an embodiment.

### DETAILED DESCRIPTION

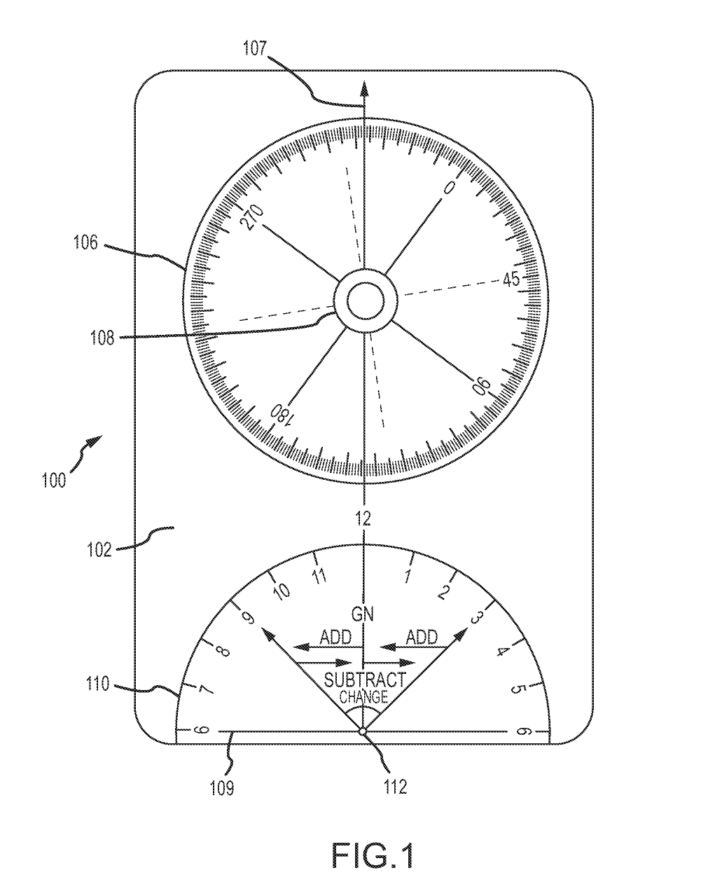

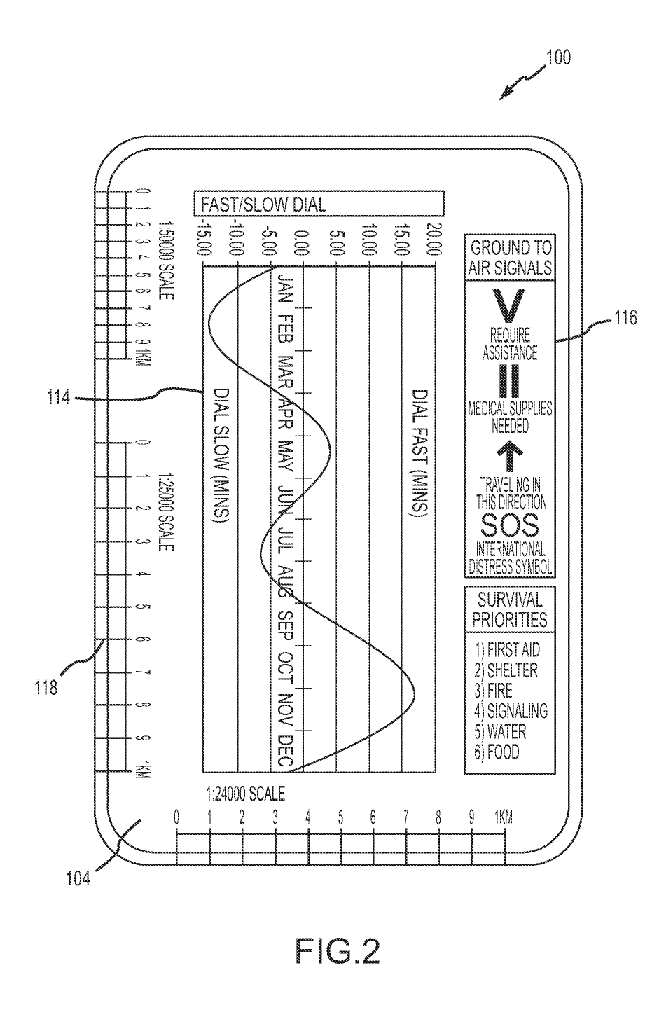

Referring now to the drawings, where like or similar elements are designated with identical reference numerals throughout the several views, and referring in particular to FIGS. 1-2, shown is a sundial compass 100 having a mounting base having a front side 102, a reverse side 104, and a bezel 106 rotatably mounted to the front side 102 at the bezel center 108. Also on the front side 102 is a dial plate 110 having time indicators between 6:00 am and 6:00 pm, and a gnomon mount indicator 112.

In some embodiments, the front side 102 may include a general topography map of a specific area. As one example, the front side 102 may include a topography map of Colorado or a relatively local area in which the sundial compass 100 may be used or sold. In some embodiments, the topography map may include other site indicators such as major crossroads or cities.

In some embodiments, the mounting base having front and reverse sides 102, 104 may be approximately the size of a credit card to allow for easy transport by an adventurer in a compartment sized for storing credit cards. The sundial compass 100 may similarly be made of lightweight materials such as paper, cardboard, plastic, or any other material desirable for transport. Plastics may include PET, PETE, HDPE, PVC, LDPE, PP, Polystyrene, or any other resin-based material.

As seen in FIG. 2, the reverse side 104 may include a time of year calibration chart 114, one or more messages 116, and/or mapping tools 118.

Returning to FIG. 1, a manner of using the sundial compass 100 is now explained. In order for the sundial compass 100 to read most accurately, it must be calibrated for several factors. These factors are the adventurer's specific location (both latitude and longitude), the equation of time and adjusting for daylight savings if it applies to the adventurer's location. However, the sundial compass 100 may be used, albeit with less accuracy, if the adventurer only knows three of the following: latitude, longitude, equation of time, and daylight savings time status.

At the outset, it should be noted that the adventurer should review the reverse side 104 of the sundial compass 100 for calibration requirements and safety tips before beginning to place the sundial compass 100 in a usable setting.

To use the sundial compass 100, the adventurer should first ensure a small hole is present at the gnomon mount indicator 112. In some embodiments, the gnomon mount indicator 112 may be a small hole present at the intersection of the true north line 107 and 6:00 line 109. In other embodiments, the gnomon mount indicator 112 may be a simple crossing of the true north line 107 and 6:00 line 109. In this embodiment, the adventurer should drill a small hole at the gnomon mount indicator 112 with a safety pin, thumb tack or other sharp object. The gnomon mount indicator 112 may be any other feature indicating an intersection of the true north line 107 and 6:00 line 109. The adventurer should be careful to not make the hole any larger than what is needed for inserting a gnomon. A gnomon is the part of a sundial that will cast the shadow.

After establishing a small hole is at the gnomon mount indicator 112, the adventurer should insert a gnomon through the hole. The gnomon may be a paper clip, blade of grass, a twig, or any other small straight member. In some embodiments, the gnomon may be supplied integrally with the sundial compass, such as a piece of the mounting base that can be detached from the mounting base.

After inserting the gnomon, the adventurer should place the sundial compass 100 on a flat surface of the ground or horizontal relative to the ground.

At this point, the adventurer should calibrate the gnomon for the current latitude to the best of his or her ability. To do this, the adventurer should bend the gnomon forward until the angle from the sundial compass 100 to the gnomon approximately matches the adventurer's current latitude. Purposely, such calibration requires that the adventurer be approximately aware of his or her latitude, as well as have an understanding of basic geometry. As an example for such calibration, Denver, Colo. is approximately 40 degrees north; therefore, the adventurer should bend the gnomon forward until he or she has approximately a 40 degree angle between mounting base of the sundial compass 100 and the gnomon.

The sundial compass will function, albeit with less accuracy, if the adventurer does not know his or her longitude, and merely bends or causes the gnomon to angle towards the mounting base at less than a 90 degree angle.

As previously mentioned, the adventurer should have first reviewed the calibration requirements on the reverse side 104 of the sundial compass 100. As seen in FIG. 2, the reverse side 104 of the sundial compass 100 may include a time of year calibration chart 114. The calibration chart 114 depicts the required adjustment that should be made when setting up the gnomon. As an example, if the day is October 26, the adventurer should adjust the gnomon to read approximately 16 minutes fast.

Returning to FIG. 1, with the sundial compass 100 flat on the ground or horizontal to the ground, the adventurer should rotate the sundial compass 100 until the shadow cast from the gnomon matches the adventurer's current clock time. For example, if the adventurer's digital watch state 10:00 am, the adventurer should rotate the sundial compass 100 until the shadow cast from the gnomon falls on the 10 in the dial plate 110. At this point, the adventurer should apply a correction of +16 minutes, as previously determined from the calibration chart 114 and a date of October 26, to the sundial compass 110 by rotating the sundial compass 110 counter clockwise. The calibration is, as can be seen, approximate, and requires the adventurer understand that the time of year affects the shadows cast, as well as charts and clocks.

Continuing with FIG. 1, the adventurer should now ideally apply a longitudinal time correction. Since the time zones are set up on a single meridian, meaning the time is set for a particular point within the time zone, the adventurer should to add or subtract minutes depending on if one is east or west of the meridian. To apply this correction, one should add 4 minutes per degree if one is west of the meridian and subtract 4 minutes per degree if one is east of the meridian. As an example, since the meridian for Mountain Time runs through Denver, there is no need to make a longitudinal correction. Again, such correction requires the adventurer understand how time zones are mapped and an approximate awareness of his or her location in relation to the time zone meridian. Again, precise knowledge is not necessary but helpful in obtaining precise directions.

Finally, the adventurer may need to correct for daylight savings. Since the current example discussed specifies the location as Denver, Colo. and the date as October 16, daylight savings time applies, at least as of the time of the submission of this disclosure. The adventurer therefore must subtract one hour by rotating the sundial compass 100 clockwise.

At this point, the sundial compass 100 is fairly precisely oriented to one of true north and true south, and the rotating bezel 106 on the sundial compass 100 can be used for precise azimuths required for navigation.

It should be understood that the preceding description has been primarily written with reference to true north and/or the northern hemisphere; however, it should be understood that the sundial compass 100 is equally suitable for use in the southern hemisphere, with the true north line indicating, in fact, true south.

It should also be understood by the adventurer that the sundial compass 100 is a novelty and/or survival tool. If the adventurer does not know his or her longitude is in relation to the time zone meridian, the sundial compass 100 is not rendered completely useless. Instead, it will merely be, at most, a few degrees off if the adventurer knows only 3 of the 4 required pieces of information to perfectly calibrate the sundial compass 100.

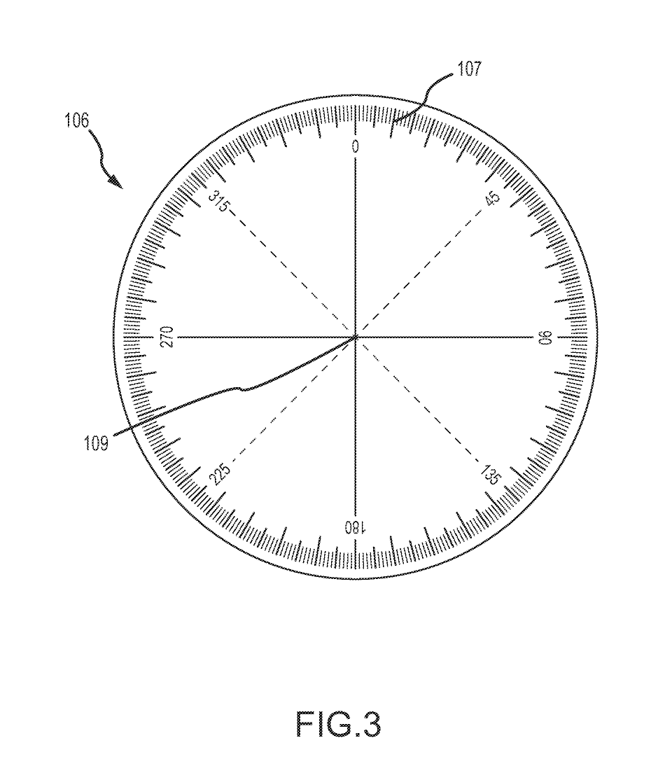

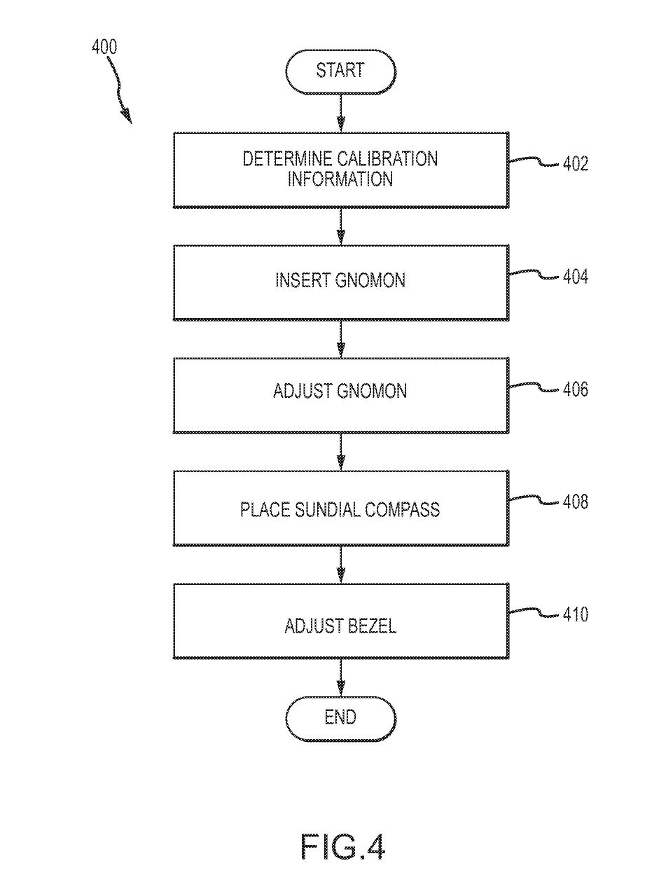

Turning now to FIG. 4, a method 400 is now discussed. In describing the method 400, it should first be understood that the method may include any or all of the steps previously discussed with reference to the sundial compass 100 depicted in and discussed in reference to FIGS. 1-3.

The method 400 includes determining calibration information 402, with the calibration information including at least three of the following: a user's latitude, a user's longitude, the present time of year, and the present daylight savings time status. Determining calibration information 402 may include reference to a topical or other map to determine a current latitude and longitude, reference to a calendar, and/or reference to a time clock to determine a daylight savings time status.

The method 400 further includes inserting a gnomon 404, which may include inserting a small straight element established at a gnomon mount indicator, such as that described with reference to FIGS. 1-3.

The method 400 further includes adjusting a gnomon 406. Adjusting a gnomon 406 may include adjusting a gnomon to be approximately perpendicular relative to a mounting base of a sundial compass, or adjusting a gnomon 406 may include adjusting a gnomon such that an angle between the gnomon and a mounting base is approximately equal to the latitude of the user's location. It should be understood that adjusting a gnomon 406 should include adjusting a gnomon to an angle matching the user's latitude if the user is approximately aware of the his or her latitudinal position.

The method 400 further includes placing a sundial compass 408. Placing a sundial compass 408 includes placing a sundial compass to determine one of true north and true south, such as that described with FIGS. 1-3 on a surface that is flat relative to a ground horizontal, or a flat portion of the ground. Placing a sundial compass 408 further includes placing a sundial compass such that a shadow cast by a gnomon falls approximately on a time indicated on a dial plate of the sundial compass that equates to the local clock time. Placing a sundial compass 408 may further include adjusting the placement to account for one or more of a time of year calibration, a longitudinal deviation from a time meridian calibration, and a daylight savings time calibration. Placing a sundial compass 408 may include any steps of placement previously described with FIGS. 1-3 to cause a shadow cast by a gnomon to fall at a particular location on a dial plate, such as the dial plate 110 shown in FIG. 1.

The method 400 may further include adjusting a bezel 410. Adjusting a bezel 410 includes rotating a bezel to guide an adventurer in a desired travel direction. As one example, after determining true north in previous steps of the method 400, one may rotate a bezel to dial-in one's desired direction of travel. If, for example, the user wishes to travel in in a southeasterly direction, ˜120 degrees of azimuth, the user should rotate the bezel 110 until the true north line 107 points to 120° on the bezel 110. Then, to travel southeast, the user would then rotate his or her body to align with the 120° mark on the bezel 110 to begin travel.

Embodiments of the invention can be embodied in a variety of ways. In addition, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all action may be expressed as a means for taking that action or as an element which causes that action. Similarly, each physical element disclosed should be understood to encompass a disclosure of the action which that physical element facilitates. Regarding this last aspect, the disclosure of a “gnomon” should be understood to encompass disclosure of the act of “casting a shadow”—whether explicitly discussed or not—and, conversely, were there only disclosure of the act of “adjusting a shadow”, such a disclosure should be understood to encompass disclosure of a “gnomon.” Such changes and alternative terms are to be understood to be explicitly included in the description.

In conclusion, the present invention provides, among other things, a system and method for determining a direction based on the time. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A sundial compass, comprising:
a mounting base having a true north line, a dial plate, and a gnomon mount indicator; wherein
the true north line and dial plate are configured to indicate one of true north and true south based on a time clock calibration.

2. The sundial compass of claim 1, further comprising:
a compass bezel rotatably mounted to the mounting base and centered on the true north line.

3. The sundial compass of claim 1, further comprising:
a detachable bezel rotatably mounted to the mounting base and centered on the true north line.

4. The sundial compass of claim 2, further comprising:
a time of year calibration chart, wherein values on the time of year calibration chart are used to offset the dial plate relative to a shadow cast by a gnomon extending from the gnomon mount indicator.

5. The sundial compass of claim 1, wherein the dial plate comprises equally spaced marks corresponding to twelve hours of a day.

6. The sundial compass of claim 5, wherein the true north line extends through a mark corresponding to noon.

7. The sundial compass of claim 5, wherein the marks are arranged radially from the gnomon mount indicator.

8. The sundial compass of claim 1, wherein the true north line extends from the gnomon mount indicator.

9. The sundial compass of claim 8, wherein the true north line extends from the gnomon mount indicator through a mark on the dial plate corresponding to noon.

10. The sundial compass of claim 1, further comprising:
a detachable gnomon.

11. The sundial compass of claim 1, wherein:
the mounting base comprises one or more of paper, cardboard, PET, PETE, HDPE, PVC, LDPE, PP, polystyrene and other resin-based materials.

12. The sundial compass of claim 1, wherein:
the mounting base is configured to fit within a credit card compartment.

13. A method of determining direction, comprising:
determining calibration information, the calibration information comprising at least three of: a user's latitude, a user's longitude, the present time of year, and the present daylight savings time status;
inserting a gnomon into a gnomon mount indicator on a mounting base of a sundial compass, the mounting base having a true north line, a dial plate, and a gnomon mount indicator;
adjusting the gnomon based on the known calibration information and a time clock calibration;
placing the sundial compass such that the true north line indicates one of true north and true south; and
determining one of true north and true south.

14. The method of claim 13, further comprising:
placing the sundial compass such that a shadow cast by the gnomon falls approximately on a time indicated on a dial plate of the sundial compass that equates to the local clock time.

15. The method of claim 13, further comprising one of:
adjusting the gnomon to be approximately perpendicular relative to a mounting base of a sundial compass;
adjusting the gnomon such that an angle between the gnomon and the mounting base is approximately equal to the latitude of the user's location; and
adjusting the gnomon such that an angle between the gnomon and the mounting base is less than ninety degrees.

16. The method of claim 15, further comprising:
adjusting a placement of the sundial compass to account for one or more of: a time of year calibration, a longitudinal deviation from a time meridian calibration, and a daylight savings time calibration.

17. The method of claim 13, further comprising:
adjusting a bezel by rotating the bezel to guide a user in a desired travel direction.

18. The method of claim 13, further comprising:
storing the sundial compass within a compartment sized for storing credit cards.

19. The method of claim 13, further comprising:
creating a hole at a gnomon mount indicator.

20. A method of manufacturing a sundial compass, the method comprising:
providing a mounting base, mounting base comprising a front side, and a reverse side, the front side comprising a gnomon mount indicator, a true north line, a dial plate, and a bezel mount; and
rotatably attaching a compass bezel to the front side of the mounting base such that calibration of the sundial compass relative to a gnomon, a local time clock time, and at least three of a user's latitude, a user's longitude, a time of year, and a daylight savings time calibration enables the sundial compass to indicate one of true north and true south.
